(19) United States
(12) Patent Application Publication
(10) Pub. No.: US 2024/0375984 A1
(43) Pub. Date: Nov. 14, 2024

(54) METHOD AND SYSTEM FOR WASTEWATER RECLAMATION

(71) Applicant: James John Peterson, San Diego, CA (US)

(72) Inventor: James John Peterson, San Diego, CA (US)

(21) Appl. No.: 18/662,568

(22) Filed: May 13, 2024

Related U.S. Application Data
(60) Provisional application No. 63/501,926, filed on May 12, 2023.

(51) Int. Cl. C02F 9/00; C02F 1/44; C02F 1/78; C02F 3/08; C02F 101/16; C02F 101/30

(52) U.S. Cl. CPC C02F 9/00; C02F 1/444; C02F 1/78; C02F 3/085; C02F 2101/16; C02F 2101/306; C02F 2209/03; C02F 2209/20; C02F 2209/23; C02F 2209/40

(57) ABSTRACT

A method and system for the reclamation of secondary or tertiary municipal wastewater contaminated with ammonia and pharmaceuticals and wherein the systemic output is explicitly for use in industrial cooling, as feed to reverse osmosis, and as feed to advanced oxidation processes. A module having a footprint substantially less than current wastewater reclamation facilities entirely the gas transfer device, the upflow bioreactor, the media separator and a strainer that facilitates the method and system. Throughout the reclamation process, the streams interconnecting the systemic influent and the systemic output or effluent is under various pressures about standard atmospheric pressure to enable the smaller footprint of the module.

### CROSS-REFERENCE TO RELATED APPLICATION

This application claims the benefit of priority of U.S. provisional application No. 63/501,926, filed 12 May 2023, the contents of which are herein incorporated by reference.

### BACKGROUND OF THE INVENTION

The present invention relates to wastewater recycling and, more particularly, to a method and system for wastewater reclamation. More particularly, a method for improving the water quality from municipal wastewater treatment plant effluent known as secondary or tertiary effluent specifically in terms of ammonia, microplastics, pharmaceuticals, pesticides, personal care products, enteric virus, total organic carbon (TOC) and protozoan cysts/oocysts. Secondary treatment follows settling and applies additional biological processes like aeration and activated sludge treatment to break down dissolved and suspended biosolids using biological treatment. Tertiary treatment adds a third, more advanced and rigorous level of treatment in the form of filtration. Both terms are known to those skilled in the art of wastewater treatment.

Water scarcity is an increasingly concerning global issue. As populations grow and weather patterns change or swing between drought or floods, the stresses on existing water infrastructures grow. Wastewater reclamation is a growing practice that is one part of attempts to develop new water sources. However, as wastewater reclamation use expands, the need for higher water quality is necessary to serve customers such as those who use reclaimed water for industrial cooling, potable reuse and/or may require downstream application of reverse osmosis desalination. Wastewater water quality improvement requires oxygen transfer in conjunction with bacteria either suspended in solution or attached to a growth medium, which requires large amounts of space, land, operational resources, and money due to the limited oxygen transfer that can occur under atmospheric pressure. Additionally, the collection of data regarding the quality of the wastewater is an important need as downstream uses are impacted by water quality. As recycled water demand expands to meet the needs of industrial cooling, irrigation, and direct/indirect potable reuse applications (IPR/DPR), there is an immediate opportunity to improve water quality from municipal secondary and tertiary effluents. Ammonia, microplastics, pharmaceuticals, pesticides, personal care products, TOC, enteric virus, and protozoan cysts/oocysts are key examples of how current treatment infrastructure is often deficient in meeting the goals of existing and future recycled water consumers.

Current practice includes biological oxidation of wastewater followed by filtration and disinfection. Biological oxidation typically employs the activated sludge process or an attached growth process such as a trickling filter or rotating biological contactor. Alternatively, membrane bioreactors incorporate the filtration using a membrane directly in a suspended growth activated sludge bioreactor. Recycled water production can be deficient in complete oxidation, resulting in ammonia, pharmaceuticals, viruses, TOC, cysts, oocysts and microplastics to be present in the effluent. The limiting factor often in sizing the oxidation portion of biological treatment is the rate of oxygen uptake in the bioreactor. The limiting factor to produce industrial cooling water may be ammonia. The limiting factors in the production of highly treated wastewater may be log credit removal of virus, or log credit removal of cysts or oocysts due to cost or footprint of treatment processes.

As can be seen, there is a need for a wastewater recycling method and system that requires less land, is better suited to remote operation and data collection and produces more reclaimed wastewater in lower concentrations of ammonia, microplastics, pharmaceuticals, pesticides, personal care products, enteric virus, and protozoan cysts/oocysts with less time and with less expense.

### SUMMARY OF THE INVENTION

The present invention solves these problems by providing a completely pressurized water reclamation method and system that increases ozone and/or oxygen concentration for oxidation, intensifies the concentration and population of bacteria, and provides ultrafiltration or microfiltration of oxidized wastewater using a method of filtration integrity monitoring that can assure a certain level of virus, cyst, and oocyst rejection. The method and system of the present invention presents an excellent opportunity for new water supplies. The method and system of the present invention yields a high-rate treatment process that enables a smaller footprint at lower cost, as well as allowing for decentralized installation, located at municipal wastewater treatment plants that grants access to more customers by improving water quality at an economical cost. Further, the small footprint allows the system of the present invention to be shop fabricated, thereby saving time and money. Additionally, the design of the system is well suited for remote operation and data collection.

In one aspect of the present invention, a method for improving the water quality from municipal wastewater treatment plant effluent known as secondary or tertiary effluent specifically in terms of ammonia, microplastics, pharmaceuticals, pesticides, personal care products, TOC, enteric virus, and protozoan cysts/oocysts.

The equipment is shop fabricated into modules that can be installed at municipal wastewater treatment plants. The present invention enables shop-fabricate modules housing equipment that can treat up to 400,000 gallons per day per module, removing ammonia, microplastics, pharmaceuticals, pesticides, personal care products, TOC, enteric virus, and protozoan cysts/oocysts with the entire system under pressure less than 80 psi, thereby being energy efficient, and reducing chemical use and associated costs and liabilities.

In another aspect of the present invention, a method of producing reclaimed wastewater, includes the following: introducing ozone and/or oxygen into an influent stream consisting of secondary or tertiary wastewater at atmospheric or lower pressure, pressurizing the influent wastewater stream to a first pressure having a minimum pressure of 10 to 80 pounds per square inch (PSI); uniformly super-oxygenating the pressurized influent wastewater stream so as to dissolve the ozone and/or oxygen and output a non-effervescent oxygenation water stream; upflowing the non-effervescent oxygenation water stream through a fluidized bed bioreactor at an upflow rate between three gallons per minute per square foot (GPMSF) and six GPMSF so as to output a bioreactor effluent stream; and combining a first stream of the bioreactor effluent stream at the same pressure of between 10 PSI and 80 PSI to the pressurized influent wastewater stream prior to said uniform super-oxygenation thereof, whereby greater than atmospheric pressure is applied to said streams throughout the method of producing reclaimed wastewater; urging a second stream of the bioreactor effluent through the fluidized bed bioreactor, wherein the second stream comprises a media configured to facilitate a biofilm growth; urging a third stream of the bioreactor effluent through an ultrafiltration membrane, wherein pressurizing the influent wastewater stream does not involve a spray pressure nozzle (wherein the prior art uses a spray to improve oxygen diffusion, which is not needed in the present invention); screening the influent and third stream, separately, each by way of a strainer of less than 500 micrometers, the pressurized influent wastewater stream prior to said uniform super-oxygenation thereof; providing a module having a production footprint of greater than 2000 gal/ft2, wherein said streams are entirely housed in the module during the method of producing reclaimed wastewater; and controlling the level of oxidation through addition of ozone, such that the non-effervescent oxygenation water stream comprises a ratio of 0.4 to 0.8 milligrams per liter (MG/L) of ozone to MG/L of total organic carbon (TOC).

In yet another aspect of the present invention a system for treating wastewater includes the following: an influent pressure source configured to pressurize an influent, the influent pressure source having a source outlet; oxygenation and, in some embodiments, adding ozone prior to pressurization or following pressurization but in each case prior to super oxygenation, a gas transfer device having a gas transfer inlet and a gas transfer outlet, wherein the source outlet is in fluid communication with the gas transfer inlet so that the influent is pressurized prior to communicating with the gas transfer inlet; an upflow bioreactor fluidly coupled to the gas transfer outlet, the upflow bioreactor having a bioreactor inlet and a bioreactor outlet; a media separator having a separator inlet and a separator outlet, wherein the separator inlet is in fluid communication with the bioreactor outlet, and wherein the separator outlet is in fluid communication with the upflow bioreactor; and a strainer having filter openings in fluid communication with the gas transfer inlet and a systemic output, wherein the gas transfer device is configured to uniformly super-oxygenate pressurized influent so as to output a non-effervescent oxygenated water stream through the gas transfer outlet, the gas transfer device includes a Speece cone or a hydrophobic membrane contactor, or venturi device, wherein the gas transfer device is configured so that the non-effervescent oxygenated water stream has an ozone concentration based on an influent stream continuous measurement of total organic carbon (TOC) so that the non-oxygenated water stream comprises a ratio of 0.4 to 0.8 mg/L of ozone to mg/L of TOC, wherein the upflow bioreactor comprises a bioreactor operating pressure of between 10 pound per square inch psi to 80 psi within a plurality of bioreactor vessels, wherein each bioreactor vessel has a diameter and a height, wherein the diameter ranges from one foot to four feet, and wherein the height ranges from 12 feet to 18 feet, wherein the upflow bioreactor comprises a bioreactor upflow rate between three gallons per minute per square foot gpm/f\hat{ }2 and six gpm/f\hat{ }2, wherein the upflow bioreactor comprises a granular activated carbon media with size range between 40 mesh and 8 mesh and wherein the bioreactor upflow rate enables an empty bed contact time range of 10 to 20 minutes; a recirculation pump configured to combining a portion of an effluent from the separator outlet to the gas transfer inlet, wherein the recirculation pump is configured to generate a recirculation stream flow of between 0% and 200% of a feed flow, wherein the influent comprises a secondary or tertiary municipal wastewater source contaminated with ammonia, microplastics, pharmaceuticals, pesticides, personal care products, TOC, enteric virus, and protozoan cysts/oocysts and wherein the systemic output is explicitly for use in industrial cooling, and/or as feed to reverse osmosis, and/or as feed to advanced oxidation processes; and a module having a predetermined footprint, wherein the upflow bioreactor is entirely housed in the module.

These and other features, aspects and advantages of the present invention will become better understood with reference to the following drawings, description, and claims.

### BRIEF DESCRIPTION OF THE DRAWINGS

FIG. 1 depicts a system according to an exemplary embodiment of the present invention.

FIG. 2 depicts a schematic view according to an exemplary embodiment of the present invention.

FIG. 3 depicts a flow chart according to an exemplary embodiment of the present invention.

FIG. 4 is a perspective view of a plurality of first bioreactor columns according to an exemplary embodiment of the present invention.

FIG. 5 is a perspective view of a plurality of second bioreactor columns of the present invention, demonstrating the range of module sizes and the configuration of the bioreactors, which can fit into a systemic module.

FIG. 6 depicts a method according to an embodiment of the present invention.

FIG. 7 is a perspective schematic view of a systemic module 200 that would have a module footprint less than 300 square feet (‘L’×‘W’) while still housing one or more upflow bioreactors.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention since the scope of the invention is best defined by the appended claims.

Broadly, an embodiment of the present invention provides a method and system for the reclamation of secondary or tertiary municipal wastewater including an optional screening apparatus that screens wastewater taken in by the system under pressure to remove debris and particulate in the wastewater. The method and system then include a fine screening apparatus of less than 500-micron screen perforation diameter that provides a secondary point to remove smaller debris and particulate from the wastewater while under pressure.

The system and method then combine the screened wastewater with a bioreactor recycle stream that operates between 0% and 200% of feed flow under pressure. Subsequently, the combined wastewater and bioreactor stream are superoxygenated and ozonated while under pressure, creating a superoxygenated and ozonated stream. Ozone concentration is determined by continuous online measurement of total organic carbon (TOC) and applied to the combined feedwater/recycle stream at a ratio of 0.4 to 0.8 mg/L O3 to TOC. Oxygen target concentration is measured at the effluent of the bioreactor (12) with a target concentration of less than 1 mg/L. Ozone and oxygen gas transfer may be accomplished using a membrane diffuser with pore size less than 1 um, like the method as described in U.S. Pat. No. 10,591,231. Alternatively, gas transfer could be employed in a similar fashion to U.S. Pat. No. 9,315,402, however it should be noted that U.S. Pat. No. 9,315,402 teaches the process order configuration of Bioreactor/Membrane>Gas Transfer>Recycle, which provides a different result as the feed does not become uniformly oxygenated prior to introduction to the integrated membrane bioreactor system. This approach would provide a lower achievable dissolved oxygen concentration and would yield membrane fouling, however, may provide a benefit of oxygen control. Alternatively, ozone and oxygen could be introduced to the feed stream by means of another common device such as a venturi or diffuser, both known to those skilled in the art of gas transfer.

After superoxygenation and ozonation, the ozonated and/or superoxygenated stream is then fed into an upflow fluidized bed bioreactor containing a media to facilitate biofilm growth in and on the superoxygenated stream. The bioreactor operates at a maximum pressure of 80 psi with a typical operating pressure ranging from 10-60 psi. Bioreactor pressure vessels range in diameter from 12″ to 48″ and height of 12 feet to 18 feet and are arranged in parallel groups of 4 to 24 to form production trains. Operating empty bed contact time (EBCT) ranges between 10 to 30 minutes and production upflow rates between 3 gpm/ft2 and 6 gpm/ft2. Biogrowth media is granular activated carbon (GAC) with size ranging between 40 mesh and 8 mesh. While in the upflow fluidized bed bioreactor, the superoxygenated stream and biofilm growth are mechanically processed to maintain a consistent thickness and oxygen uptake into the biofilm growth, creating a bioreactor effluent. a portion of the bioreactor effluent is directed to a media separation step, followed by a fine strainer of less than 500 micron and then pressurized ultrafiltration membrane and disinfection system that filters and disinfects the bioreactor effluent. The disinfected effluent may then be considered reclaimed and suitable for public use and may be directed through public waterways and pipe networks to customers. The term disinfection may also be used interchangeably with advanced oxidation processes (AOP). AOP may contain a range of processes, but most commonly uses 03 with hydrogen peroxide or UV with hydrogen peroxide.

The present invention thus provides a system and method that treats secondary or tertiary municipal wastewater effluent under pressure and at a higher rate than conventional systems, resulting in a more compact system that increases oxygen concentration, reduce concentrations of ammonia, microplastics, pharmaceuticals, pesticides, personal care products, enteric virus, total organic carbon and protozoan cysts/oocysts and can be shop fabricated to save time and money and also produces less odor.

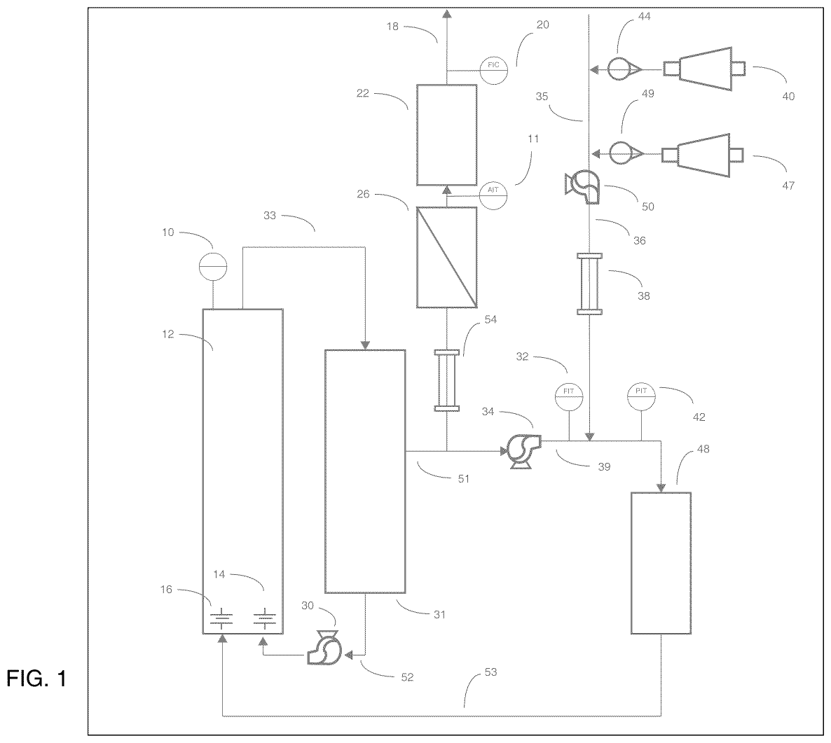

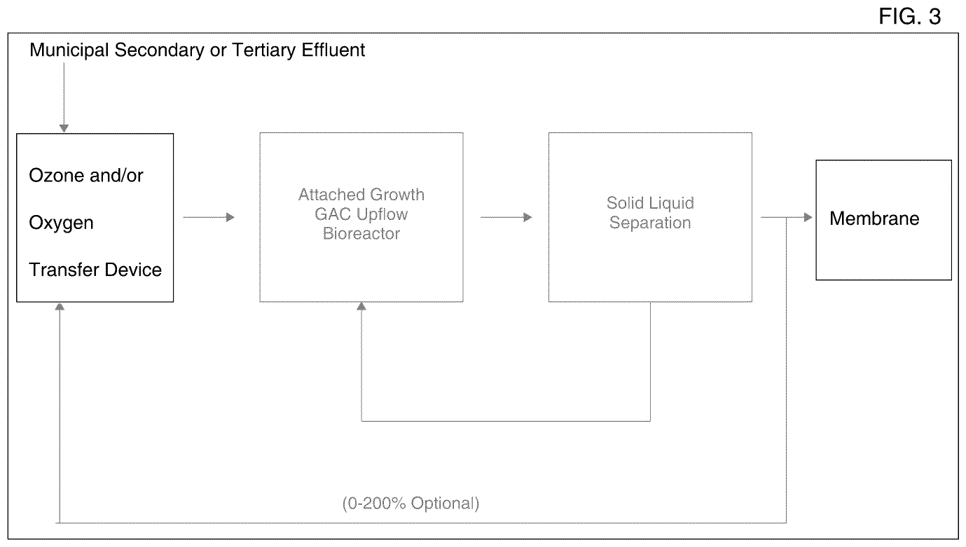

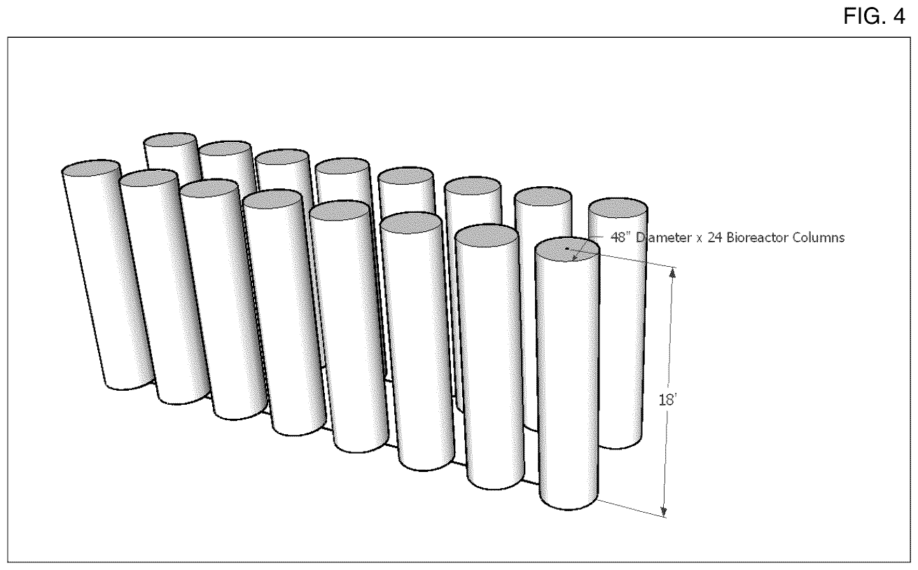

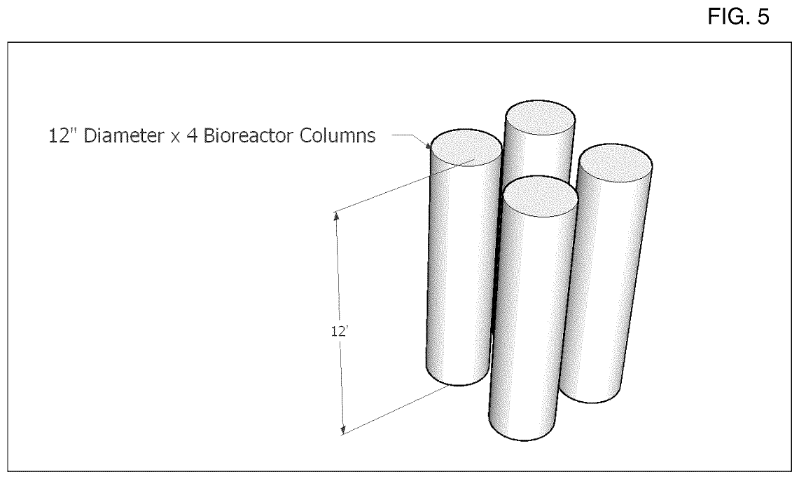

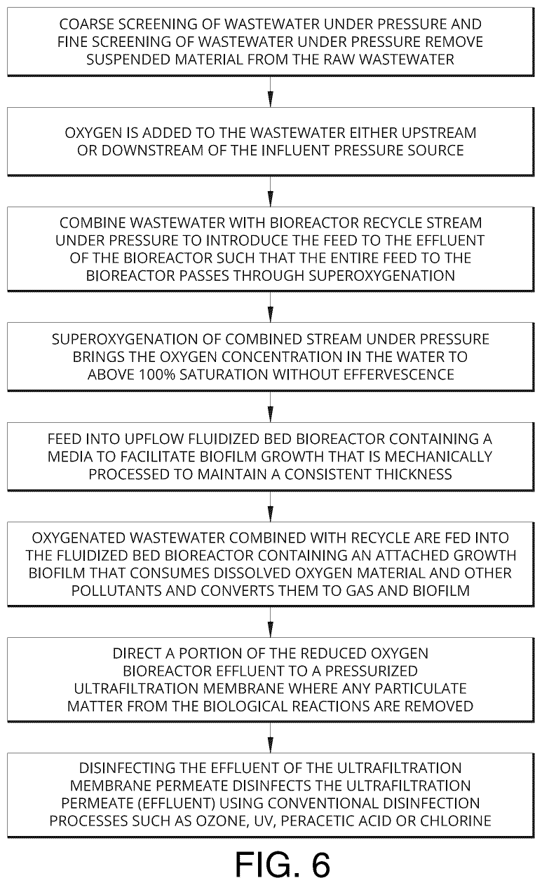

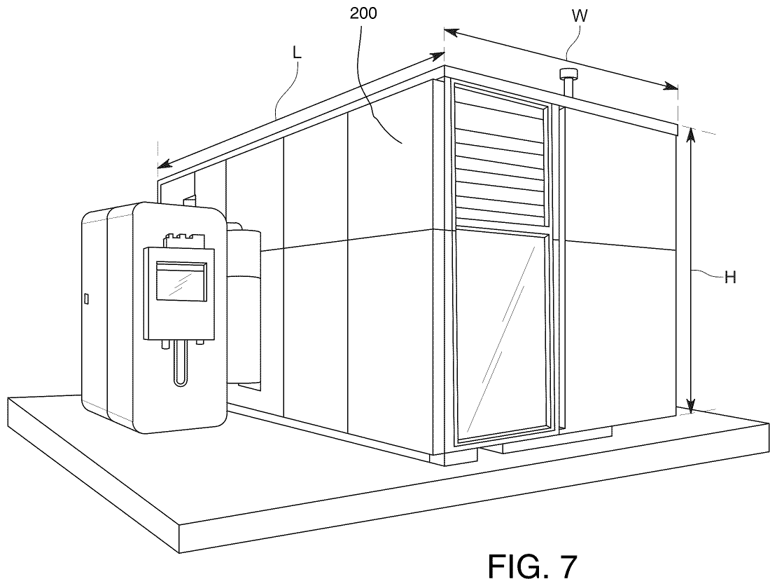

Referring now to FIGS. 1 through 7, embodiments of the system and method in accordance with the present invention are shown. FIG. 1 depicts a system according to the present invention, with an influent stream of wastewater being mixed with an oxygen source 47 and optionally an ozone source 40, then taken in by an influent pressure source 50 and pumped out as a pressurized wastewater stream 36. The pressurized wastewater stream 36 is passed through fine screening 38, such as a 200 m disc strainer, to remove smaller debris and particulate.

Once the pressurized wastewater stream and ozone and/or oxygen mixture 36 is screened, it passes through a pressure monitor 42 to ensure that the combined pressurized wastewater stream 36 and recycle stream 39 are at a minimum pressure of 10 psi, not more than 80 psi prior to gas transfer in the superoxygenation device. The combined pressurized wastewater stream 36 and recycle stream 39 are then fed into a superoxygenation device 48, which dissolves ozone from an ozone source 40 and oxygen from an oxygen source 47 to increase the oxygen and ozone concentration in the upflow bioreactor feed stream 53. The superoxygenation device 48 adds oxygen to the process water that results in oxygenated water without bubbles or effervescence, such resulting water referred herein to as non-effervescent water. The superoxygenation device 48 may be a Speece cone or an oxygen absorption cone. The superoxygenation device 48 monitors and controls the supply of oxygen fed from the oxygen source 47 to the unpressurized wastewater stream 35 with an oxygen measurement and flow control device 49. Oxygen gas flow is measured and controlled based on the effluent oxygen concentration of the bioreactor.

To avoid having to pressurize the oxygen and ozone, the influent pressure source/feed pump 50 is downstream the ozone sources 40 and oxygen sources 47 so that these gasses are fed into the suction of the feed pump which helps to mix and pressurizes prior to the gas transfer device 48. It should be understood that the ozone sources 40 and oxygen sources 47 may be downstream of the feed pump 50 in certain embodiments.

After being superoxygenated, the pressurized wastewater stream 36 enters an aerobic up flow fluidized bioreactor 12 through a water distribution device 16. Media separated in the vortex 31 is also fed into the aerobic bioreactor 12 through a media distribution device 14 so that the media facilitates a biofilm growth in the bioreactor effluent stream 33 within the aerobic bioreactor 12. A media level measurement device 10 is attached to the aerobic bioreactor 12 to ensure the necessary operating level and volume of media for optimal biofilm conditions are present in the aerobic bioreactor 12. The bioreactor pressure is controlled based on the feed pressure as it is directly connected to the feed. The feed rate is controlled based on the retention time in the system to facilitate efficient oxygen uptake. Retention time is measured as the volume of the bioreactor divided by the flow. The recycle flow is balanced to maintain a consistent velocity through the bioreactor and may be a fixed multiple of the influent pressurized wastewater stream 36 and controlled by the speed of the recycle pump 34. The media separated in vortex media separation system can be returned in same location as feed to bioreactor through parallel distributor 14.

Once a sufficient level of biofilm has been grown within the aerobic bioreactor 12, a combined stream of the pressurized wastewater stream 33 and the media passes out of the aerobic bioreactor 12 before being separated into distinct streams of pressurized wastewater stream 51 and media 52. Media is separated in a vortex media device 31. The separated media is then recirculated into the aerobic bioreactor 12 via a media recirculation pump 30. The separated pressurized wastewater stream 51 is then further split into a recirculation stream 39 and an effluent stream 18. The recirculation stream flow rate 39 is equal to the flow rate of water exiting the bioreactor, less the influent flow rate, measured as volume divided by time such as gallons per minute. The flow rate (gallons/minute) not to be confused with recycle rate which is a ratio. The influent and effluent flow rates are equivalent. The recycle rate is equal to the flow rate of water exiting the recycle pump 34, divided by the influent flow rate and may range between 0% and 200% of feed flow in order to maintain an upward velocity in the bioreactor ranging between 3 gpm/ft2 and 6 gpm/ft2. The recirculation stream passes through a water recirculation pump 34 and flow monitor 32 to be combined with a new pressurized wastewater stream 36. The recycle rate may be controlled based on the level of the fluidized bed, a multiple of feed flow or oxygen concentration in the bioreactor effluent. The effluent stream 18 is passed through a fine screen 54 followed by an ultrafiltration membrane 26, such as a DOW SFP-2880, to remove any remaining media or particulate. The ultrafiltration membrane 26 may be a submerged hollow fiber ultrafiltration membrane operating under a pressure driving force.

A dissolved oxygen concentration measurement device 11 then ensures that the effluent stream 18 is sufficiently oxygenated before the effluent stream 18 passes into a disinfection device 22. Sufficient oxygen would be a concentration of between 0 mg/L and 2 mg/L to ensure that the majority of oxygen was consumed in the bioreactor. A flow and measurement control device 20 then allows properly disinfected effluent 18 to exit the system and be passed on to customers. The ultrafiltration or microfiltration membrane includes a method of integrity validation using measurement of pressure loss rate of compressed air applied at a known initial pressure to the interior of the membrane fiber to validate log removal of virus and cysts/oocysts.

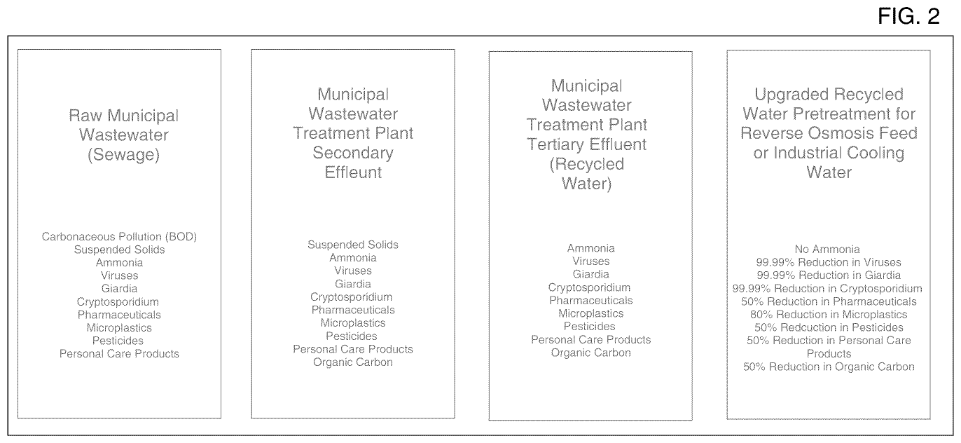

Referring now to FIG. 2, an embodiment of a method according to the present invention is shown. First an influent of wastewater is pressurized before being passed through optional coarse and fine screening devices, that removes suspended debris and particulate materials from the pressurized influent wastewater. Oxygen may be added to the wastewater before or after the wastewater is pressurized. Ozone may be added to the water concurrently with oxygen in concentrations ranging from 0 mg/L to 6 mg/L or based on the influent TOC concentration in a ratio of 0.4 to 0.6 mg/L O3 to mg/L TOC. The pressurized influent wastewater is then combined with a bioreactor recycle stream of water within the system, to ensure the entire feed of water to the bioreactor is superoxygenated. Once combined, the combined stream of pressurized water passes through a superoxygenation device to increase the oxygen concentration within the combined stream of pressurized water above 100% saturation without effervescence.

The superoxygenated stream is then fed into an uplow fluidized bed bioreactor, and combined with a separate stream of media that facilitates biofilm growth in the superoxygenated stream. The superoxygenated stream, media, and growing biofilm in the bioreactor are mechanically separated and processed to maintain a consistent thickness of fluid within the bioreactor. The growth biofilm consumes dissolved oxygen and other pollutants in the combined superoxygenated water and media fluid and converts the dissolved oxygen and other pollutants into gas and biofilm.

A stream of reduced oxygen fluid is then passed as effluent from the bioreactor and split, with a portion of the bioreactor effluent passed to a pressurized ultrafiltration membrane, and another portion of the bioreactor effluent being recycled within the system. The bioreactor effluent that passes through the ultrafiltration membrane has any remaining particulate removed from the stream before passing through a disinfectant device. The disinfection of the stream may be done through a variety of methods, including, but not limited to, ozone, UV, hydrogen peroxide, peracetic acid, or chlorine disinfection methods.

The present invention thus provides a wastewater reclamation system and method that is compact and inexpensive. The method and system allow for suspended material to be removed from raw wastewater, allow wastewater to be combined with a recycled water feed to ensure complete superoxygenation of the water in the system, allow system water to have an oxygen concentration above 100% saturation without effervescence, allow a fluidized bed containing media to combine with superoxygenated water such that a biofilm may grow and remove pollutants and oxygen from the superoxygenated water, allow ozone to oxidize pollutants, and allow a portion of the reduced oxygen bioreactor effluent to have any remaining particulates removed and be disinfected so that it may be reused.

Prescreening the municipal secondary or tertiary wastewater reduces organic content of the wastewater and protects the bioreactor by removing material that may plug the distribution system. Recycling of the bioreactor effluent enables consistent expansion of the fluidized bed resulting in optimized oxygen mass transfer. Superoxygenation provides excess oxygen for biological treatment without effervescence which may disrupt biofilm adhesion and growth. Ozonation oxidizes the wastewater and helps to facilitate removal of pharmaceuticals, viruses and cycts/oocycts. The fluidized bed reactor provides superior oxygen mass transfer through the provision of a high biofilm surface area capable of consuming the elevated oxygen delivered from the superoxygenation system. Ultrafiltration removes particulate organic matter and residual biofilm released from the fluidized bed bioreactor. Integrity monitoring of the ultrafiltration membrane through use of a pressure decay test in accordance with regulatory requirements, validates removal of virus and protozoan cysts/oocysts between 2 and 6 log removal. And disinfection of ultrafiltrate effluent provides water quality suitable for reuse and is performed more efficiently on ultrafiltration effluents due to the lack of suspended material and low effluent turbidity.

Also, while the present invention is discussed primarily in the context of a wastewater recycling machine, the present invention may also include applications in wastewater effluent polishing machines and industrial wastewater treatment machines.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A method of producing reclaimed wastewater, the method comprising:
pressurizing an influent wastewater stream to a first pressure having a minimum pressure of 10 pounds per square inch (PSI) and a maximum pressure of 80 PSI;
uniformly super-oxygenating the pressurized influent wastewater stream so as to output a non-effervescent oxygenation water stream;
upflowing the non-effervescent oxygenation water stream through a fluidized bed bioreactor at an upflow rate between three gallons per minute per square foot (GPMSF) and six GPMSF so as to output a bioreactor effluent stream; and
combining a first stream of the bioreactor effluent stream to the pressurized influent wastewater stream prior to said uniform super-oxygenation thereof,
whereby greater than atmospheric pressure is applied to said streams throughout the method of producing reclaimed wastewater.

2. The method of claim 1, further comprising urging a second stream of the bioreactor effluent through the fluidized bed bioreactor.

3. The method of claim 2, wherein the second stream comprises a media configured to facilitate a biofilm growth.

4. The method of claim 2, further comprising urging a third stream of the bioreactor effluent through an ultrafiltration membrane.

5. The method of claim 1, wherein pressurizing the influent wastewater stream does not involve a spray nozzle intended to diffuse water into smaller particles.

6. The method of claim 1, further comprising screening, by way of a strainer of less than 500 micrometers, the pressurized influent wastewater stream prior to said uniform super-oxygenation thereof.

7. The method of claim 1, adding an oxygen source to the influent wastewater stream prior to pressurizing the influent wastewater stream to the first pressure.

8. The method of claim 1, further controlling uniformly super-oxygenating of the pressurized influent wastewater stream so that a combination of the said first stream and the pressurized influent wastewater stream comprises a ratio of 0.4 to 0.8 milligrams per liter (MG/L) of ozone to MG/L of total organic carbon (TOC).

9. A system for treating wastewater, the system comprising:
an influent pressure source configured to pressurize an influent, the influent pressure source having a source outlet;
a gas transfer device having a gas transfer inlet and a gas transfer outlet, wherein the source outlet is in fluid communication with the gas transfer inlet so that the influent is pressurized prior to communicating with the gas transfer inlet;
an upflow bioreactor fluidly coupled to the gas transfer outlet, the upflow bioreactor having a bioreactor inlet and a bioreactor outlet;
a media separator having a separator inlet and a separator outlet, wherein the separator inlet is in fluid communication with the bioreactor outlet, and wherein the separator outlet is in fluid communication with the upflow bioreactor; and
a submerged hollow fiber ultrafiltration membrane operating under a pressure driving force.

10. The system of claim 9, wherein the gas transfer device is configured to uniformly super-oxygenated pressurized influent so as to output a non-effervescent oxygenated water stream through the gas transfer outlet.

11. The system of claim 10, the gas transfer device comprises a Speece cone.

12. The system of claim 10, the gas transfer device comprises a hydrophobic membrane contractor which permeates oxygen into the wastewater.

13. The system of claim 10, wherein the gas transfer device is configured so that the non-oxygenated feed water stream has an ozone concentration is based on a continuous measurement of a total organic carbon (TOC) so that a combination of the said first stream and the pressurized influent wastewater stream comprises a ratio of 0.4 to 0.8 milligrams per liter (MG/L) of ozone to MG/L of TOC.

14. The system of claim 9, wherein the upflow bioreactor comprises a bioreactor operating pressure of between 10 pound per square inch (PSI) to 80 PSI within a plurality of bioreactor vessels, wherein each bioreactor vessel has a diameter and a height, wherein the diameter ranges from one foot to four feet, and wherein the height ranges from 12 feet to 18 feet.

15. The system of claim 9, wherein the upflow bioreactor comprises a bioreactor upflow rate between three gallons per minute per square foot (GPMSF) and six GPMSF.

16. The system of claim 15, wherein the upflow bioreactor comprises a granular activated carbon (GAC) media with size range between 40 mesh and 8 mesh and wherein the bioreactor upflow rate enables an empty bed contact time range of 10 to 20 minutes.

17. The system of claim 9, further comprising a recirculation pump configured to combining a portion of an effluent from the separator outlet to the gas transfer inlet.

18. The system of claim 17, wherein the recirculation pump is configured to generate a recirculation stream flow of between 0% and 200% of the influent or effluent flow of the system.

19. The system of claim 18, wherein the influent comprises a secondary or tertiary municipal wastewater source contaminated with ammonia, microplastics, pharmaceuticals, pesticides, personal care products, TOC, enteric virus, and protozoan cysts/oocysts and wherein the systemic output is explicitly for use in industrial cooling, as feed to reverse osmosis, and as feed to advanced oxidation processes.

20. The system of claim 19, further comprising a module having a footprint of less than 300 square footage, wherein the upflow bioreactor is housed in the module.
